(19) United States
(12) Patent Application Publication
(10) Pub. No.: US 2013/0278248 A1
(43) Pub. Date: Oct. 24, 2013

(54) DETERMINING THE ANGULAR POSITION OF ROTOR

(71) Applicants: Marcus Gutzmer, Garbsen (DE); Uwe Krause, Pattensen (DE); Uwe Nolte, Barsinghausen (DE)

(72) Inventors: Marcus Gutzmer, Garbsen (DE); Uwe Krause, Pattensen (DE); Uwe Nolte, Barsinghausen (DE)

(73) Assignee: SIEMENS AKTIENGESELLSCHAFT, Munich (DE)

(21) Appl. No.: 13/977,379

(22) PCT Filed: Dec. 21, 2011
(86) PCT No.: PCT/EP2011/073539

§ 371 Date: Jun. 28, 2013

(30) Foreign Application Priority Data
Dec. 30, 2010 (DE) 10 2010 056 468.0

(51) Int. Cl. G01B 7/30

(52) U.S. Cl. CPC G01B 7/30
USPC 324/207.22

(57) ABSTRACT

An angular position transmitter determines the angular position of the rotor of a motor using at least one magnet indirectly or directly connected to the motor shaft and at least one magnetically sensitive storage unit having a plurality of storage cells arranged such that at least some of the storage cells are magnetized by the magnet. The storage cells are read, and the angular position is determined from a geometric position of the magnetized cells.

### CROSS REFERENCE TO RELATED APPLICATIONS

This application is based on and hereby claims priority to International Application No. PCT/EP2011/073539 filed on Dec. 21, 2011 and German Application No. 10 201 0 056 468.0 filed on Dec. 30, 2010, the contents of which are hereby incorporated by reference.

### BACKGROUND

Described below are a method for determining the angular position of a rotor of a motor, an angular position transmitter and a motor.

The electronic actuation of motors and/or a load frequently requires knowledge of the position. Particularly with multi-turn applications (in other words where the motor covers a number of rotations between the end positions), it is of significant interest to know the absolute position.

The acquisition of the position for single-turn applications is already achieved in various ways, such as for instance by:
incremental encoders (also with index track),
optical absolute encoders (n tracks produce an angular resolution of 2̂n),
resolvers,
magnetic acquisition e.g. using Hall or GMR effect (Giant MagnetoResistance),
capacitive methods and
resistive methods.

With the exception of the first two methods, all others operate on an analog basis and prepare the measurement signal for the subsequent processing by AD converters.

With multi-turn applications, it is possible to store the number of rotations either mechanically (e.g. by drives) or electrically (e.g. in a non-volatile storage device).

### SUMMARY

A simple solution for determining the angular position of a rotor is achieved by a method in which at least one magnet is indirectly or directly connected to a motor axle and at least one magnetically sensitive storage device having several storage cells is arranged such that at least some of the storage cells are magnetized by the magnet. The storage cells are read out and the angular position is determined from a geometric position of the magnetized cells.

The position for single turn applications can be digitally acquired, magnetically directly, by a digital storage device being read out on a magnetic basis (e.g. MRAM, magnetoresistive Random Access Storage) which is sensitive to external magnetic fields. The angular position can be determined just as easily since the geometric position of the magnetized cells allows direct conclusions to be drawn as to the angular position of the magnet (and thus the angular position of the rotor, since the magnet is connected to the motor axle). In this way the magnet can be embodied differently, e.g. as a simple bar magnet or as a multi-pole magnet. The possibility of conclusions being drawn as to the angular position from the “magnetic pattern” in the magnetic storage cells is decisive. The geometric position of the magnetized cells on the storage device (chip) is then a direct measure of the rotor position.

The proposed solution operates without an AD converter and provides a measurement signal directly on a digital basis. Savings are thus made on the corresponding analog circuit technology including all associated problems (such as for instance adjustment errors, offset errors and temperature errors as well as EMC and climate sensitivity).

In an advantageous form of the embodiment, at least one statistical method is used to determine the angular position. The precision when determining the angular position can herewith be increased for instance by geometric averaging.

In a further advantageous embodiment, the magnet is magnetized centrically and is arranged eccentrically in respect of the motor axle. This variant allows for an especially simple evaluation, since, upon rotation of the motor axle, the storage cells of the magnetically sensitive storage device which correspond to the inner magnetization of the magnet are overwritten by the other magnetization and the angular position of the rotor almost results from the (x/y) position of the storage cells corresponding to the internal magnetization.

In a further advantageous embodiment, a number of rotations is stored in a non-volatile storage device. The method can in this way also be applied to multi-turn applications, wherein the position is stored permanently throughout a drop in the voltage.

In a further advantageous embodiment, the magnetically sensitive storage device is used here as the non-volatile storage device and the number which is not magnetized by the magnet is stored in at least one storage cell. Therefore in comparison with a single-turn angular transmitter, a multi-turn transmitter with permanent storage of the position is possible for multi-turn applications without additional expense, wherein (storage) areas on the magnetically sensitive chip (the storage device) are used, which are not influenced by the magnetic field of the magnet to be detected.

In a further advantageous embodiment, at least one storage cell is shielded from the magnet such that it is not magnetized hereby. As a result, the magnetically sensitive storage device can then also be used if no regions remain uninfluenced by the arrangement/dimensions of the magnet and storage device.

### BRIEF DESCRIPTION OF THE DRAWINGS

These and other objects and advantages of the present invention will become more apparent and more readily appreciated from the following description of exemplary embodiments, taken in conjunction with the accompanying drawings of which:

FIG. 1 is a schematic representation of a motor,

FIG. 2 is a schematic representation of the magnetized storage cells.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

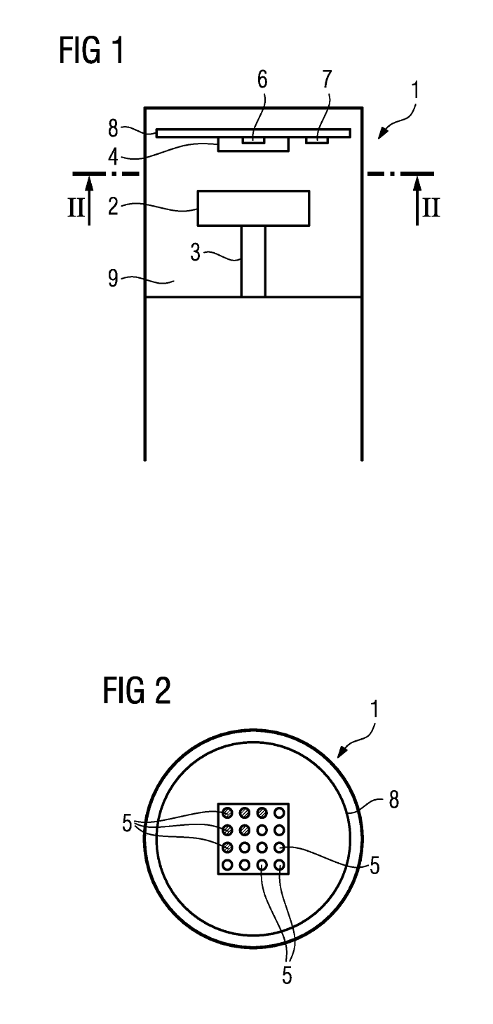

FIG. 1 shows a motor 1 with an angular position transmitter, formed of at least one magnet 2, a magnetically sensitive storage device 4, a read-out unit 6 and an evaluation unit 7. The magnet 2 is attached to the motor axle 3 and thus performs its rotations therewith. According to the respective position of the magnet 2, the storage cells 5 (see FIG. 2) of the storage device 4, which can be embodied for instance as an MRAM, are magnetized. With a simple magnet 2 having a north and a south pole, roughly half (according to the arrangement shown) of the storage cells 5 are N-magnetized and the other half are S-magnetized.

The storage cells 5 are read out by a read-out unit 6. On the basis of their magnetization (north/south) and the geometric position of the magnetized cells on the chip 4, the evaluation unit 7 determines the angular position of the magnet 2 and thus also that of the rotor. The evaluation unit 7 may in this way be a component of a possibly existing circuit board 8, which can be arranged in a motor cover 9 as shown in the Figure.

Instead of a simple magnet 2, a multi-polar magnet, e.g. 4-pole, can also be used, which is then advantageously attached eccentrically with respect to the rotor axle 3, so that the “magnetic pattern” on the chip 4 allows for clear conclusions to be drawn as to the angular position of the rotor. Similarly possible is an embodiment with two or more smaller magnets, with which a clear “pattern” can likewise be generated. The use of a number of (smaller) magnetic storage devices is naturally also possible. In a particularly advantageous variant, a centrically (annular) magnetized magnet is arranged eccentrically in respect of the motor axis 3 so that with a rotation of the motor axle 3, the storage cells 5 corresponding to the internal magnetization of the magnet are overwritten by the external magnetization, and the angular position of the rotor can practically be concluded from the (x/y-) position of the storage cells 5 on the magnetically sensitive storage device 4, the storage cells corresponding to the internal magnetization.

Thus, a module (the storage device 4), which was not developed for this area (determining the angular position) and which exhibits unwelcome sensitivities for the original application (data storage) is applied precisely in this area, in order in this way to use the sensitivity to its advantage. Here the does not require an AD converter and supplies a measurement signal directly on a digital basis, as a result of which the corresponding analog circuit technology, along with all associated problems, can be dispensed with.

FIG. 2 shows a top view of the magnetically sensitive storage device 4 with its storage cells 5, wherein the storage device 5 is arranged on the printed circuit board 8. The shaded circles stand for N-magnetized cells 5, the empty circles for S-magnetized cells. The angular position of the magnet 2 with the north and south pole from top left to bottom right already emerges “at a glance” from the geometric position of the respective cells. The evaluation unit 7 (not shown here) correspondingly determines the angular position of the rotor of the motor 1 from this pattern in order to advantageously increase the accuracy using at least one statistical method.

In order to use the angular position transmitter as a multi-turn transmitter, the number of rotations is stored in a non-volatile storage device. This can be integrated into the printed circuit board for instance (or a storage device already present there is “shared”), storage cells 5, which are anyway either not influenced by the magnetic field of the magnet 2 (conversely to the representation) or are shielded accordingly, can however also be used for storing the number of rotations. Therefore not only is the rotary angle—detected, as with each single-turn transmitter, but the position is also permanently stored without additional effort throughout a drop in the voltage, wherein a (linear) position of a moveable element driven by the motor can naturally also be concluded from the number of rotations together with the current angular position. Examples of systems in which the method can be advantageously used are automatically actuatable opening mechanisms such as elevator doors for instance.

In summary, to specify a simple solution for determining the angular position of a rotor, it is proposed to connect at least one magnet indirectly or directly to a motor axle, to assign at least one magnetically sensitive storage with several storage cells, such that at least some of the storage cells are magnetized by the magnet, to read out the storage cells and to determine the angular position from a geometric position of the magnetized cells.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. A method for determining the angular position of a rotor of a motor, comprising:
connecting at least one magnet indirectly or directly to a motor axle;
arranging at least one magnetically sensitive storage device with a number of storage cells, such that at least some of the storage cells are magnetized by the magnet;
reading the storage cells; and
determining the angular position from a geometric position of magnetized storage cells in the at least one magnetically sensitive storage device.

15. The method as claimed in claim 14, wherein said determining uses at least one statistical method to determine the angular position.

16. The method as claimed in claim 14, wherein the magnet is magnetized centrically and arranged eccentrically with respect to the motor axle.

17. The method as claimed in claim 14, further comprising storing a number of rotations of the motor axle in a non-volatile storage device.

18. The method as claimed in claim 17, wherein the at least one magnetically sensitive storage device is a non-volatile storage device and the number of rotations is stored in at least one storage cell not magnetized by the magnet.

19. The method as claimed in claim 18, wherein the at least one magnetically sensitive storage device includes at least one shielded storage cell that is shielded from being magnetized by the magnet.

20. An angular position transmitter for determining the angular position of a rotor of a motor having a motor axle, comprising:
at least one magnet connected, during operation of said angular position transmitter, indirectly or directly to the motor axle;
at least one magnetically sensitive storage device with a number of storage cells arranged such that at least some of the storage cells are magnetized by the magnet when the rotor is rotated during operation of said angular position transmitter; and
an evaluation unit reading the storage cells and determining the angular position from a geometric position of magnetized cells in the at least one magnetically sensitive storage device.

21. The angular position transmitter as claimed in claim 20, wherein the evaluation unit determines the angular position using at least one statistical method.

22. The angular position transmitter as claimed in claim 20, wherein the magnet is magnetized centrically and eccentrically with respect to the motor axle.

23. The angular position transmitter as claimed in claim 20, further comprising a non-volatile storage device storing a number of rotations of the motor axle.

24. The angular position transmitter as claimed in claim 20, wherein the magnetically sensitive storage device is a non-volatile storage device and includes at least one storage cell that is not magnetizable by the magnet in which is stored a number of rotations of the motor axle.

25. The angular position transmitter as claimed in claim 24, wherein the at least one storage cell is shielded from the magnet to prevent magnetization by the magnet.

26. A motor, comprising:
a rotor
a motor axle, and
an angular position transmitter including
at least one magnet connected, during operation of the angular position transmitter, indirectly or directly to the motor axle;
at least one magnetically sensitive storage device with a number of storage cells arranged such that at least some of the storage cells are magnetized by the magnet when the rotor is rotated; and
an evaluation unit reading the storage cells and determining the angular position from a geometric position of magnetized cells in the at least one magnetically sensitive storage device.
